(19) United States
(12) Patent Application Publication
(10) Pub. No.: US 2021/0387335 A1
(43) Pub. Date: Dec. 16, 2021

(54) Method And Control System For Determining Dynamic Friction Torque, And Industrial Robot

(71) Applicant: ABB Schweiz AG, Baden (CH)

(72) Inventors: Josef Holmner, Umeå (SE); Görgen Johansson, Västerås (SE)

(21) Appl. No.: 17/281,624

(22) PCT Filed: Oct. 12, 2018
(86) PCT No.: PCT/EP2018/077843

§ 371 Date: Mar. 31, 2021

(51) Int. Cl. B25J 9/16; B25J 9/12; B25J 19/00

(52) U.S. Cl. CPC B25J 9/1633; B25J 9/126; B25J 19/0004; B25J 9/1651; B25J 9/1653; B25J 9/163

(57) ABSTRACT

A method for determining a dynamic friction torque of a frictional brake device of a joint of an industrial robot, the method including performing a disengaged brake movement of an electric motor of the joint while the brake device is disengaged; determining a disengaged brake torque value based on a torque reference of a control loop of the electric motor during the disengaged brake movement; performing an engaged brake movement of the electric motor while the brake device is engaged; determining an engaged brake torque value based on a torque reference of the control loop during the engaged brake movement; and determining the dynamic friction torque of the brake device based on a difference between the engaged brake torque value and the disengaged brake torque value. A control system and an industrial robot are also provided.

### TECHNICAL FIELD

The present disclosure generally relates to determination of a dynamic friction torque of a frictional brake device. In particular, a method for determining a dynamic friction torque of a frictional brake device of a joint of an industrial robot, a control system for determining a dynamic friction torque of a frictional brake device of a joint of an industrial robot, and an industrial robot comprising such control system, are provided.

### BACKGROUND

The performance of frictional brake devices in an industrial robot is important for many reasons, such as safety. The brake devices are therefore often tested, e.g., by a service engineer running a testing program.

A frictional brake device of an industrial robot may sometimes contain some quantities of oil and/or contaminants. In such cases, the brake device may still have a high static friction torque. The dynamic friction torque, however, may be very low due to the oil and/or contaminants. As a consequence, there is a risk of unintentional sliding of one or more link members of the industrial robot, for example due to gravity. Some testing programs for brake devices only detect the static friction torque, and not the dynamic friction torque.

U.S. Pat. No. 6,711,946 B2 discloses a method for monitoring the state of a motor brake. By means of the method in a measuring sequence in speed-regulated operation, the brake is applied for a short time and over this time a motor current is measured and the brake torque is determined on the basis of the thus obtained measuring data.

### SUMMARY

One object of the present disclosure is to provide a method for accurately determining a dynamic friction torque of a frictional brake device of an industrial robot.

A further object of the present disclosure is to provide a simple and/or cheap method for determining a dynamic friction torque of a frictional brake device of an industrial robot.

A still further object of the present disclosure is to provide a safe method for determining a dynamic friction torque of a frictional brake device of an industrial robot.

A still further object of the present disclosure is to provide a method for determining a dynamic friction torque of a frictional brake device of an industrial robot, which method solves several or all of the foregoing objects in combination.

A still further object of the present disclosure is to provide a control system for determining a dynamic friction torque of a frictional brake device of an industrial robot, which control system solves one, several or all of the foregoing objects.

A still further object of the present disclosure is to provide an industrial robot solving one, several or all of the foregoing objects.

According to one aspect, there is provided a method for determining a dynamic friction torque of a frictional brake device of a joint of an industrial robot, the method comprising performing a disengaged brake movement of an electric motor of the joint while the brake device is disengaged; determining a disengaged brake torque value based on a torque reference of a control loop of the electric motor during the disengaged brake movement; performing an engaged brake movement of the electric motor while the brake device is engaged; determining an engaged brake torque value based on a torque reference of the control loop during the engaged brake movement; and determining the dynamic friction torque of the brake device based on a difference between the engaged brake torque value and the disengaged brake torque value.

The disengaged brake torque value reflects “non-brake” dynamic friction torque in the joint and potential gravity torque. The engaged brake torque value also reflects the “non-brake” dynamic friction torque in the joint, and potential gravity torque, but also the dynamic friction torque. Thus, by subtracting the disengaged brake torque value from the engaged brake torque value, the dynamic friction torque can be accurately determined with compensation for non-brake dynamic friction torque and potential gravity torque.

The torque reference of the control loop is based on modelled values, and not only based on measured values. The use of the torque reference of the control loop in order to determine the dynamic friction torque of a brake device according to the present disclosure provides several advantages.

By determining the dynamic friction torque of the brake device based on the torque reference of the control loop, the dynamic friction torque can be determined more accurately. This is because the torque reference can be sampled at far higher frequencies than for example motor current measured by an AD (analog-to-digital) converter. In contrast, to an AD converter, the resolution of the torque reference is not limited by hardware resolution. The determination of the dynamic friction torque based on the torque reference according to the method can therefore provide more accurate results than, for example, a determination based on a measured motor current.

The sampling frequency of the torque reference is in practice only limited by the clock frequency of a data processing device of the control system of the industrial robot. Tests by the applicant have shown that a determination of the dynamic friction torque based on the torque reference provides very accurate and reliable results.

Furthermore, by utilizing an already existing control loop of the electric motor to determine the dynamic friction torque, no additional hardware is needed, such as sensors for measuring motor current and/or temperature of the brake device. The method according to the present disclosure may determine the dynamic friction torque only based on the torque reference of the control loop. The torque reference is already used in control loops of some existing industrial robots for the control of associated electric motors. The control loop may not have to be modified in any way for determining the dynamic friction torque according to the method.

Furthermore, in some existing solutions for testing the functionality of a brake device, a link member of the industrial robot is accelerated up to a high speed to generate a high kinetic energy before the brake device is applied. This type of testing however requires large movements of the link member. For this reason, a safety zone has to be established or maintained around the industrial robot. In contrast, the determination of the dynamic friction torque of the brake device based on the torque reference of the control loop according to the present disclosure can be made with only very small movements of a link member of a joint.

According to one example, the disengaged brake movement is performed before the engaged brake movement. However, the disengaged brake movement and the engaged brake movement may be performed in any order. Furthermore, only one disengaged brake movement and only one engaged brake movement may be necessary in order to determine the dynamic friction torque according to the method.

The method may be carried out automatically, for example each time after a robot program has been executed, or each time after one or more particular instructions of a robot program have been executed. Throughout the present disclosure, the electric motor may be an electric servo motor.

The dynamic friction torque may be determined as the difference between the engaged brake torque value and the disengaged brake torque value. That is, the difference does not have to be processed further in order to determine the dynamic friction torque.

The engaged brake movement may be performed at a substantially constant speed, or at a constant speed. As used herein, a substantially constant speed may differ less than 5%, such as less than 1%, from a constant target speed.

The method may further comprise accelerating the electric motor from standstill while the brake device is engaged prior to the engaged brake movement. Thus, in case the disengaged brake movement is performed before the engaged brake movement, the electric motor may come to a full stop before performing the engaged brake movement. In this case, the brake device may be engaged when the electric motor is stopped. The electric motor may then accelerate the electric motor, with the brake engaged, from standstill, e.g., to the constant speed of the engaged brake movement.

The disengaged brake movement may be performed at a substantially constant speed, or at a constant speed. Alternatively, or in addition, the method may further comprise accelerating the electric motor from standstill while the brake device is disengaged prior to the disengaged brake movement.

The disengaged brake movement and the engaged brake movement may be performed in the same direction. In this case, the electric motor may perform a reverse brake movement between the performance of the disengaged brake movement and the performance of the engaged brake movement. A movement range of a link member of the joint, within which the disengaged brake movement and the engaged brake movement are performed, can thereby be further reduced. Thus, the disengaged brake movement and the engaged brake movement may at least partly “overlap”, e.g., be carried out at least partly in a common angular range (in case the electric motor is a rotational electric motor). According to one example, the disengaged brake movement and the engaged brake movement are started from substantially the same position, or the same position, of the electric motor. In case the reverse brake movement is performed, the electric motor may come to a full stop after each of the disengaged brake movement and the reverse brake movement.

The engaged brake torque value may be determined based on a plurality of values of the torque reference sampled at a frequency of at least 50 Hz, such as at least 300 Hz, such as at least 50 Hz.

The joint may be a rotational joint and the electric motor may be a rotational electric motor. In this case, a summed angular distance of the disengaged brake movement of the electric motor and the engaged brake movement of the electric motor may correspond to an angular distance of a link member of the joint of less than 3 degrees, such as less than 2 degrees. For example, the summed angular distance of the electric motor may be approximately 60 degrees, which may correspond to an angular distance of the link member of less than 1 degree. A link member movement of 1 degree is barely noticeable for the human eye. If the reverse brake movement is performed by the electric motor between the disengaged brake movement and the engaged brake movement, the total movement range of the electric motor is reduced below the summed angular distance. The joint may comprise a transmission, such as a gearbox, operatively coupled between the electric motor and the driven member.

A joint according to the present disclosure does however not necessarily need to be a rotational joint. A method according to the present disclosure may also be used for translational joints.

The torque reference may be calculated based on a deviation between an actual speed and a reference speed of the electric motor. The actual speed and the reference speed may be calculated based on a measured position and a reference position, respectively.

Alternatively, or in addition, the torque reference may be based on a dynamic model of the joint. Thus, the torque reference may be at least partly based on a modelled value generated by the dynamic model.

The dynamic model may define the dynamics of the electric motor. Furthermore, if the electric motor is connected to a link member via a transmission, also the dynamics of the transmission and/or the link member may be defined in the dynamic model. The torque reference may be a reference torque of the electric motor.

According to a further aspect, there is provided a control system for determining a dynamic friction torque of a frictional brake device of a joint of an industrial robot, the control system comprising a data processing device and a memory having a computer program stored thereon, the computer program comprising program code which, when executed by the data processing device, causes the data processing device to perform the steps of commanding an electric motor of the joint to perform a disengaged brake movement while the brake device is disengaged; determining a disengaged brake torque value based on a torque reference of a control loop of the electric motor during the disengaged brake movement; commanding the electric motor to perform an engaged brake movement while the brake device is engaged; determining an engaged brake torque value based on a torque reference of the control loop during the engaged brake movement; and determining the dynamic friction torque of the brake device based on a difference between the engaged brake torque value and the disengaged brake torque value.

According to a further aspect, there is provided an industrial robot comprising a control system according to the present disclosure and at least one joint having an electric motor and a frictional brake device.

### BRIEF DESCRIPTION OF THE DRAWINGS

Further details, advantages and aspects of the present disclosure will become apparent from the following embodiments taken in conjunction with the drawings, wherein:

FIG. 1: schematically represents a side view of an industrial robot;

FIG. 2: schematically represents a control system of the industrial robot in FIG. 1;

FIG. 3: schematically represents a joint of the industrial robot; and

FIG. 4: schematically represents an electric motor and an associated drive unit comprising a control loop.

### DETAILED DESCRIPTION

In the following, a method for determining a dynamic friction torque of a frictional brake device of an industrial robot, a control system for determining a dynamic friction torque of a frictional brake device of an industrial robot, and an industrial robot comprising such control system, will be described. The same reference numerals will be used to denote the same or similar structural features.

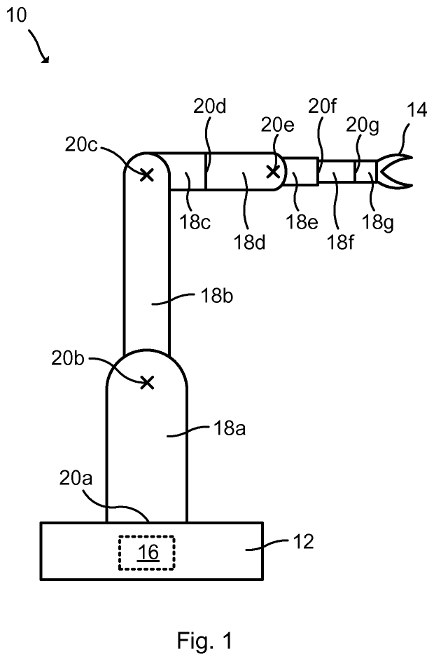

FIG. 1 schematically represents a side view of an industrial robot 10. The industrial robot 10 is exemplified as a seven-axis industrial robot but the present disclosure is not limited to this type of robot. An industrial robot according to the present disclosure may comprise at least three axes.

The industrial robot 10 of this example comprises a base member 12, a tool 14, and a control system 16, such as a robot controller. The industrial robot 10 further comprises a first link member 18a rotatable around a vertical axis relative to the base member 12 at a first joint 20a, a second link member 18b rotatable around a horizontal axis relative to the first link member 18a at a second joint 20b, a third link member 18c rotatable around a horizontal axis relative to the second link member 18b at a third joint 20c, a fourth link member 18d rotatable relative to the third link member 18c at a fourth joint god, a fifth link member 18e rotatable relative to the fourth link member 18d at a fifth joint 20e, a sixth link member 18f translationally movable relative to the fifth link member 18e at a sixth joint 20f, and a seventh link member 18g rotatable relative to the sixth link member 18f at a seventh joint 20g. The seventh link member 18g comprises an interface (not denoted) to which the tool 14 is attached. A brake device according to the present disclosure may be provided at one, several or each of the joints 20a-20g. Each of the joints 20a-20g is also collectively referred to with reference numeral “20” and each of the link members 18a-18g is also collectively referred to with reference numeral “18”.

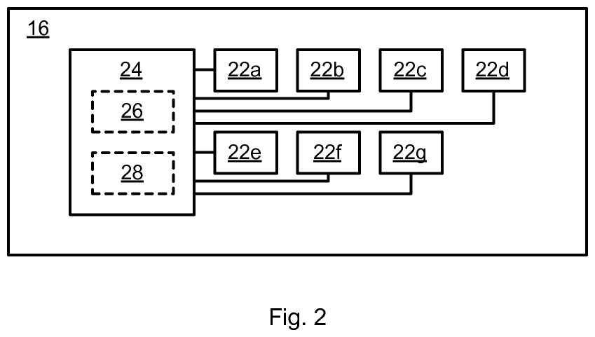

FIG. 2 schematically represents one example of control system 16 of the industrial robot 10 in FIG. 1. The control system 16 comprises a plurality of drive units 22a-22g, each drive unit 22a-22g associated with one joint 20a-20g. Each drive unit 22a-22g is configured to produce a drive signal (e.g., alternating current) for driving an electric motor of an associated joint 20a-20g. One drive unit 22a-22g may however alternatively drive a plurality of electric motors. Each of the drive units 22a-22g is also collectively referred to with reference numeral “22”.

The control system 16 further comprises a main computer 24 having a data processing device 26 (e.g., a central processing unit, CPU) and a memory 28. A computer program, such as a robot program, is stored in the memory 28. The computer program may comprise program code which, when executed by the data processing device 26, causes the data processing device 26 to execute any step, or to command execution of any step, according to the present disclosure. The main computer 24 may generate signals representing reference positions for the electric motors to the drive units 22a-22g, e.g., based on movement instructions from the robot program.

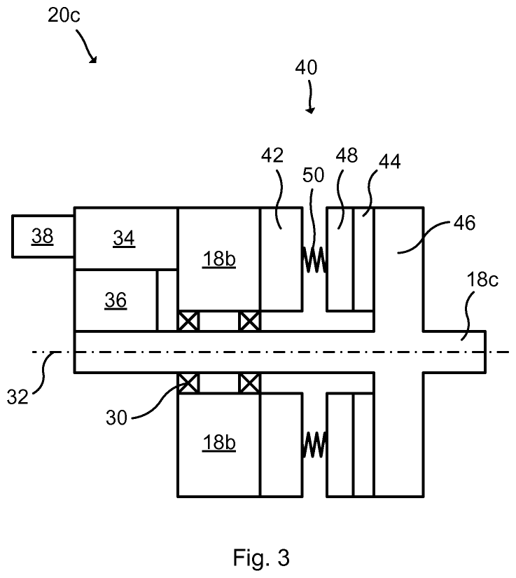

FIG. 3 schematically represents one example of a joint of the industrial robot 10. In FIG. 3, the joint is exemplified as the third joint 20c in which the third link member 18c is rotationally coupled to the second link member 18b via bearings 30 for rotation about a rotational axis 32. The joint 20c comprises an electric motor 34 for driving the third link member 18c relative to the second link member 18b. As shown in FIG. 3, the joint 20c comprises a transmission 36, e.g., a gearbox, such that the third link member 18c is driven by the electric motor 34 via the transmission 36.

The joint 20c further comprises a position sensor 38, e.g., a resolver, associated with the electric motor 34. The position sensor 38 is arranged for real-time detection of the rotational position of the electric motor 34. A signal representing the measured position of the electric motor 34 is sent to the control system 16. Optionally, the joint 20 also comprises a speed detection sensor (not shown) for real-time detection of the rotational speed of the electric motor 34.

The joint 20C further comprises a brake device 40. In this example, the brake device 40 is a power-off brake, i.e., the brake device 40 stops or holds a load when electrical power is either accidentally lost or intentionally disconnected. The brake device 40 serves to apply braking energy to relative rotational movements about the rotational axis 32 between the third link member 18c and the second link member 18b. Brake devices according to the present disclosure are however not limited to power-off brakes or to rotational brakes.

The brake device 40 of this example comprises an electromagnetic member 42 fixedly connected to the second link member 18b. The electromagnetic member 42 houses a coil (not shown). The brake device 40 further comprises an annular rotatable frictional brake disk 44. The brake disk 44 is connected to the third link member 18c via a hub 46. The brake device 40 further comprises an annular armature plate 48 and a plurality of elastic elements 50, here implemented as compression springs.

In FIG. 3, the brake device 40 adopts an engaged state where no current is applied to the coil of the electromagnetic member 42 and no magnetic field is thereby generated. The elastic elements 50 push the armature plate 48 into engagement with the brake disk 44 and frictional braking energy is thereby generated provided that there is relative rotational movement between the third link member 18c and the second link member 18b. When applying current to the coil of the electromagnetic member 42, a magnetic field is generated which attracts the armature plate 48 towards the electromagnetic member 42 against the compression of the elastic elements 50. An air gap is established between the brake disk 44 and the armature plate 48 and the brake device 40 thereby adopts a disengaged state.

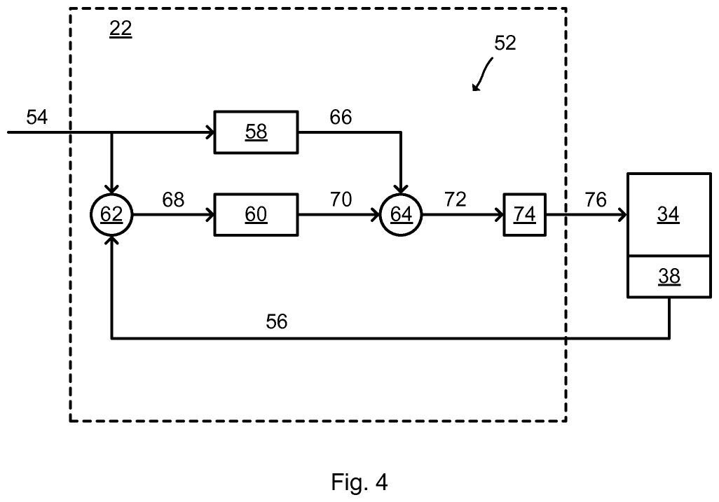

FIG. 4 schematically represents the electric motor 34 and an associated drive unit 22 comprising one of many examples of a control loop 52. The drive unit 22 receives reference positions 54 of the electric motor 34 from the main computer 24 and measured positions 56 from the position sensor 38 of the electric motor 34.

The drive unit 22 in the example of FIG. 4 comprises a calculating element 58, a PID controller 60 (proportional-integral-derivative controller), and two summing elements 62, 64. In the calculating element 58, a disturbance torque 66 is calculated based on the reference position 54 and a dynamic model of the joint 20. A position difference 68 between the reference position 54 and the measured position 56 is continuously calculated in the summing element 62. The position difference 68 is fed to the PID controller 60 which outputs an estimated torque deviation 70. The summing element 64 sums the disturbance torque 66 and the estimated torque deviation 70 and outputs a torque reference 72 for the electric motor 34.

The torque reference 72 is sent to a drive element 74 as a reference torque of the electric motor 34. The drive element 74 outputs a drive signal 76 to the electric motor 34 based on the torque reference 72.

A dynamic friction torque of the brake device 40 may be determined by performing a disengaged brake movement of the electric motor 34 while the brake device 40 is disengaged, determining a disengaged brake torque value based on the torque reference 72 during the disengaged brake movement, performing an engaged brake movement of the electric motor 34 while the brake device 40 is engaged, determining an engaged brake torque value based on the torque reference 72 during the engaged brake movement, and determining the dynamic friction torque of the brake device 40 based on a difference between the engaged brake torque value and the disengaged brake torque value.

The dynamic friction torque of the brake device 40 may thus be defined with the following equation:

T_{df}=T_{eng}−T_{diseng} (1)

where T_{df} [Nm] is the dynamic friction torque of the brake device 40, T_{eng} [Nm] is the engaged brake torque value, and T_{diseng} [Nm] is the disengaged brake torque value. The engaged brake torque value T_{eng} contains the “non-brake” dynamic friction torque in the joint 20, potential gravity torque, and the dynamic friction torque of the brake device 40. The disengaged brake torque value T_{diseng} contains the “non-brake” dynamic friction torque in the joint 20, and potential gravity torque. Thus, the difference between T_{eng} and T_{diseng} corresponds to the dynamic friction torque T_{df} of the brake device 40.

A non-limiting example of a method for determining the dynamic friction torque according to the present disclosure will now be described. The disengaged brake torque value T_{diseng} is approximated by making a small disengaged brake movement of the electric motor 34 at constant speed from a starting position with the brake device 40 disengaged, for example 0.525 rad such that the movement takes about 2.5 s to complete. During this movement, the torque reference 72 of the control loop 52 is sampled ten times. The average value of these samples is defined as the disengaged brake torque value T_{diseng} (containing the “non-brake” dynamic friction torque in the joint 20, and potential gravity torque). After the disengaged brake movement, the electric motor 34 is stopped.

The electric motor 34 is then driven to perform a reverse brake movement back to the starting position while the brake device 40 is disengaged. In the starting position, the brake device 40 is then engaged.

The engaged brake torque value T_{eng} is then approximated by making a small engaged brake movement of the electric motor 34 of 1.05 rad at constant speed (2 rad/s) with the brake device 40 applied. The engaged brake movement is carried out in the same direction as the disengaged brake movement. During the engaged brake movement, the torque reference 72 of the control loop 52 is sampled at high frequency (about 800 Hz). The average value of these samples is defined as the engaged brake torque value T_{eng} (containing the “non-brake” dynamic friction torque in the joint 20, potential gravity torque, and the dynamic friction torque of the brake device 40).

The summed angular distance of the disengaged brake movement of the electric motor 34 and the engaged brake movement of the electric motor 34 is in this example 1.575 rad, i.e., approximately 90°. Furthermore, the total angular range of the electric motor 34, within which the disengaged brake movement, the reverse brake movement and the disengaged brake movement are performed, is in this example 1.05 rad, i.e., approximately 60° (since the engaged brake movement is larger than each of the disengaged brake movement and the reverse brake movement). The transmission 36 of the joint 20 may have a ratio of 100:1 or higher. Thus, the total angular range of the electric motor 34 corresponds to a total angular range of the link member 18 of less than 1°, which is barely visible for the user. This small movement required for testing the brake device 40 improves safety of the industrial robot 10.

The dynamic friction torque T_{df} of the brake device 40 is then determined using equation (1). The value of the dynamic friction torque is then used to determine if the brake device 40 should be replaced and/or repaired due to low dynamic friction torque, or if the brake device 40 provides a sufficient dynamic friction torque T_{df} to be considered safe. In case the determined dynamic friction torque is below a reference value, a warning may be issued, for example an audible and/or visual alarm.

While the present disclosure has been described with reference to exemplary embodiments, it will be appreciated that the present invention is not limited to what has been described above. For example, it will be appreciated that the dimensions of the parts may be varied as needed.

1. A method for determining a dynamic friction torque of a frictional brake device of a joint of an industrial robot, the method comprising:
performing a disengaged brake movement of an electric motor of the joint while the brake device is disengaged;
determining a disengaged brake torque value based on a torque reference of a control loop of the electric motor during the disengaged brake movement;
performing an engaged brake movement of the electric motor while the brake device is engaged;
determining an engaged brake torque value based on a torque reference of the control loop during the engaged brake movement; and
determining the dynamic friction torque of the brake device based on a difference between the engaged brake torque value and the disengaged brake torque value.

2. The method according to claim 1, wherein the dynamic friction torque is determined as the difference between the engaged brake torque value and the disengaged brake torque value.

3. The method according to claim 1, wherein the engaged brake movement is performed at a substantially constant speed.

4. The method according to claim 3, further comprising accelerating the electric motor from standstill while the brake device is engaged prior to the engaged brake movement.

5. The method according to claim 1, wherein the disengaged brake movement is performed at a substantially constant speed.

6. The method according to claim 1, further comprising accelerating the electric motor from standstill while the brake device is disengaged prior to the disengaged brake movement.

7. The method according to claim 1, wherein the disengaged brake movement and the engaged brake movement are performed in the same direction.

8. The method according to claim 7, further comprising performing a reverse brake movement of the electric motor between the performance of the disengaged brake movement and the performance of the engaged brake movement.

9. The method according to claim 1, wherein the engaged brake torque value is determined based on a plurality of values of the torque reference sampled at a frequency of at least 50 Hz, such as at least 300 Hz, such as at least 500 Hz.

10. The method according to claim 1, wherein the joint is a rotational joint and the electric motor is a rotational electric motor.

11. The method according to claim 10, wherein a summed angular distance of the disengaged brake movement of the electric motor and the engaged brake movement of the electric motor corresponds to an angular distance of a link member of the joint of less than 3 degrees, such as less than 2 degrees.

12. The method according to claim 1, wherein the torque reference is calculated based on a deviation between an actual speed and a reference speed of the electric motor.

13. The method according to claim 1, wherein the torque reference is based on a dynamic model of the joint.

14. A control system for determining a dynamic friction torque of a frictional brake device of a joint of an industrial robot, the control system comprising a data processing device and a memory having a computer program stored thereon, the computer program including program code which, when executed by the data processing device, causes the data processing device to perform the steps of:
commanding an electric motor of the joint to perform a disengaged brake movement while the brake device is disengaged;
determining a disengaged brake torque value based on a torque reference of a control loop of the electric motor during the disengaged brake movement;
commanding the electric motor to perform an engaged brake movement while the brake device is engaged;
determining an engaged brake torque value based on a torque reference of the control loop during the engaged brake movement; and
determining the dynamic friction torque of the brake device-0-04 based on a difference between the engaged brake torque value and the disengaged brake torque value.

15. An industrial robot comprising a control system including a data processing device and a memory having a computer program stored thereon, the computer program including program code which, when executed by the data processing device, causes the data processing device to perform the steps of:
commanding an electric motor of the joint to perform a disengaged brake movement while the brake device is disengaged;
determining a disengaged brake torque value based on a torque reference of a control loop of the electric motor during the disengaged brake movement;
commanding the electric motor to perform an engaged brake movement while the brake device is engaged;
determining an engaged brake torque value based on a torque reference of the control loop during the engaged brake movement; and
determining the dynamic friction torque of the brake device based on a difference between the engaged brake torque value and the disengaged brake torque value; and
at least one joint having an electric motor and a frictional brake device.

16. The method according to claim 2, wherein the engaged brake movement is performed at a substantially constant speed.

17. The method according to claim 2, wherein the disengaged brake movement is performed at a substantially constant speed.

18. The method according to claim 2, further comprising accelerating the electric motor from standstill while the brake device is disengaged prior to the disengaged brake movement.
